(19) United States
(12) Patent Application Publication
(10) Pub. No.: US 2025/0102729 A1
(43) Pub. Date: Mar. 27, 2025

(54) METHOD AND SEMI-FINISHED PRODUCT FOR PRODUCING A MULTICORE FIBRE

(71) Applicant: Heraeus Quarzglas GmbH & Co. KG, Hanau (DE)

(72) Inventors: Kay SCHUSTER, Bitterfeld-Wolfen (DE); Michael LORENZ, Bitterfeld-Wolfen (DE); Manuel ROSENBERGER, Bitterfeld-Wolfen (DE); Michael HÜNERMANN, Bitterfeld-Wolfen (DE); Tobias TIESS, Bitterfeld-Wolfen (DE); Thomas KAYSER, Bitterfeld-Wolfen (DE); Martin BÖTTCHER, Bitterfeld-Wolfen (DE)

(21) Appl. No.: 18/728,179

(22) PCT Filed: Jan. 17, 2023
(86) PCT No.: PCT/EP2023/050989

§ 371 Date: Jul. 11, 2024

(30) Foreign Application Priority Data
Jan. 18, 2022 (EP) 22151978.8

(51) Int. Cl. G02B 6/02; C03B 37/023

(52) U.S. Cl. CPC G02B 6/02042; C03B 37/023; C03B 2203/34

(57) ABSTRACT

Methods for producing a multicore fiber comprise a method step in which a component group is reshaped to form the multicore fiber or a pre-form for the multicore fiber, which comprises a hollow cylinder comprising a central bore and a hollow cylinder longitudinal axis, which hollow cylinder comprises a cladding glass region made of cladding glass and a plurality of core glass regions occupied by a core glass, wherein at least part of the central bore is occupied by a glass filling material. In order to provide a method for producing multicore fibers without central signal core, in which the risk of rejects during the completion of the hollow glass cladding cylinder is reduced, a marker element made of marker glass adjacent to the glass filling material is used, which extends along the longitudinal axis of the central bore.

### TECHNICAL BACKGROUND

The present invention relates to a method for producing a multicore fiber, comprising a method step in which a component group is reshaped to form the multicore fiber or into a pre-form for the multicore fiber, which comprises a hollow cylinder comprising a central bore and a hollow cylinder longitudinal axis, the hollow cylinder comprising a cladding glass region made of cladding glass and a plurality of core glass regions occupied by a core glass, wherein at least part of the central bore is occupied by a glass filling rod comprising a filling rod longitudinal axis and a filling rod outer cladding surface.

In addition, the invention relates to a semi-finished product for producing a multicore fiber, comprising a hollow cylinder comprising a central bore and a hollow cylinder longitudinal axis, the hollow cylinder comprising a cladding glass region made of cladding glass and a plurality of core glass regions occupied by a core glass within the cladding glass region, wherein at least part of the central bore is occupied by a glass filling rod comprising a filling rod longitudinal axis and a filling rod outer cladding surface.

In multicore fibers, a plurality of light wave-conducting optical core regions (also referred to below as “signal cores”) are integrated in a common fiber. The signal cores extend along the longitudinal axis of the fiber. They are surrounded by cladding material with a lower refractive index and enable light to be guided independently of each other. This fiber design promises a high signal transmission capacity, because different signals, combined in a single optical fiber, can be transmitted simultaneously in each of the spatially separated signal cores. This signal transmission method is also referred to as “spatial multiplexing,” which in particular can increase the data transmission capacity in optical telecommunications. Multicore fibers are also regarded as key components for transmitting energy for material processing, as a component of fiber optic sensors in measuring and medical technology, and are considered for lighting and imaging purposes in microscopic or endoscopic devices.

### PRIOR ART

Multicore fibers are produced by elongating a solid pre-form or a group of components. These frequently consist of synthetically produced quartz glass (SiO₂), which may be doped or undoped. The production of synthetic quartz glass comprises, for example, plasma or CVD deposition methods known by the names OVD, VAD, MCVD, PCVD or FCVD methods. A liquid or gaseous silicon-containing starting substance is subjected to a chemical reaction (hydrolysis, pyrolysis or oxidation), and the reaction product—particulate SiO₂—is deposited as a solid from the gas phase on a deposition surface. The starting substance is, for example, silicon tetrachloride (SiCl₄) or a chlorine-free silicon compound, such as a polyalkyl siloxane. The reaction zone is, for example, an oven, a burner flame or an arc (plasma).

In the so-called “stack and draw” method, core rods and glass cylinders of different diameters are stacked such that they create a relatively high packing density and a certain degree of symmetry. The cylindrical components are inserted into a sheath tube and are spatially fixed therein. This group is drawn to form the multicore fiber or is processed further in advance to form a pre-form from which the multicore fiber is then drawn.

The “stack-and-draw” method requires a high level of adjustment effort and easily results in errors in dimensional stability and in the introduction of impurities resulting from the large proportion of free component surfaces. In addition, due to differences in the radial packing density, the elongated pre-form often has different radius values in the azimuthal direction, which have to be compensated for by cylindrical grinding.

US 2022/003921 A1 describes a semi-finished product and a method for producing a multicore fiber by producing five circular openings in a cladding glass solid cylinder by heating or by powder shaping processes, wherein a centrally arranged opening is evenly surrounded by four surrounding openings and overlaps therewith. The outer four opening regions are occupied with core glass rods, a rod made of a low-viscosity glass and having a polygonal cross-section is inserted into the still free central opening region, and a marker rod is inserted into an empty space next to this rod. In a later method stage, all components of the group are heated, with the rod made of low-viscosity glass being the first to soften and fill the gaps.

A semi-finished product and a method for producing a multicore fiber by elongating the semi-finished product are known from US 2016/347645 A1. The semi-finished product forms a multipart fiber pre-form which is composed of a one-piece cladding tube made of cladding glass, designed for receiving and axially guiding a stack of three structurally identical cylindrical stack pieces made of cladding glass, each of which comprise through-bores and a longitudinal groove in the cylinder cladding surface thereof, a plurality of core rods for insertion into the through-bores, and a plurality of marker rods for insertion into the longitudinal grooves. Within the cladding tube bore, the stack pieces are arranged on top of one another such that the through-bores and the longitudinal grooves are aligned. The marker zone of the fiber pre-form formed by the marker rods runs on the inner cladding surface of the cladding tube.

U.S. Pat. No. 8,532,454 B2 discloses a multicore fiber having seven core regions.

In another known procedure for producing a pre-form for a multicore fiber, as described, for example, in US 2021/0300812 A1, a plurality of through-holes are produced by longitudinal perforation of a glass cladding cylinder based on synthetic SiO₂, which run in the direction of the longitudinal axis of the cylinder. A core rod containing a core material with a higher refractive index than the glass of the glass cladding cylinder is inserted into each of the through-holes. In the case of a large number of through-holes, a thin and easily breakable wall can remain between adjacent holes. In order to reduce the risk of breakage, it is proposed to successively produce the required number of through-holes in the glass cladding cylinder, and in the meantime to occupy and fuse at least part of the through-holes with a core rod.

The glass cladding cylinder is elongated. The through-holes thus have a large aspect ratio (ratio of length and diameter), which fundamentally makes it difficult to produce them with dimensional accuracy and align them exactly parallel to the longitudinal axis of the hollow glass cladding cylinder.

In the method known from US 2015/284286 A1 and from US 2015/0307387 A1, a hollow glass cladding cylinder in the form of a soot body based on SiO₂ produced using the OVD method (SiO₂ soot body) is used, which has a density of between 0.8 g/cm³ and 1.6 g/cm³. In the OVD method, the deposition surface is generally the outer cladding surface of a rod-shaped or tubular deposition mandrel rotating about its longitudinal axis. A substantially cylindrical soot body is deposited by a reversing back and forth movement of the reaction zone. After completion of the deposition process, the deposition mandrel is removed so that a central through-opening remains in the central axis of the cylindrical soot body. Longitudinal bores for receiving core glass rods are introduced into the hollow glass cladding cylinder produced in this way, wherein the lower density of the SiO₂ soot body compared to quartz glass makes it easier to produce dimensionally accurate longitudinal bores. The central “OVD through-opening” remaining due to the production process can lead to asymmetrical deformations when collapsing and destroy the fiber design. Collapsing also reduces the cross-sectional area of the cladding glass portion. These disadvantages can be prevented by inserting a filling rod which closes the OVD through-opening. The filling rod consists of glass which has substantially the same refractive index as the hollow glass cladding cylinder. The filling rod can also be produced by an OVD method or by press molding or by a combination of press molding and an OVD method. In addition, a channel for receiving a marker element is introduced into the hollow glass cladding cylinder. The channel is produced by mechanical drilling in the region of the hollow glass cladding cylinder that is close to the edge.

The marker elements form continuous, line-like marker zones in the multicore fiber and are used to break symmetry in order to be able to clearly identify and assign the signal cores and their positions relative to each other and in relation to the fiber central axis. This is necessary, for example, so that two multicore fibers can be joined together with low attenuation by means of their end faces using conventional splicing methods.

To splice the multicore fiber, the fiber ends to be connected are arranged such that their end faces face one another. In a known method, light is simultaneously fed into all signal cores at the opposite fiber end, and is collectively detected at the fiber end of the other multicore fiber by means of a photodetector and power meters. In particular in cases where one end of the multicore fiber is not available for feeding light, this multi-core fiber is irradiated with light from the side. By relative displacement of the multicore fiber end faces in the horizontal and vertical directions and by relative rotation in the azimuthal direction, the fiber ends are automatically aligned with one another in a fusion splicing machine until the signal cores are correctly assigned to one another and the collective received light power is at a maximum, and then fused to one another in this position.

### Technical Problem

The greater the number of multiple cores, the greater theoretically the increase in the data transmission capacity compared to an optical fiber having a single fiber core (single-mode fiber or multi-mode fiber). On the other hand, there is in principle the requirement for each of the multiple cores to have optical attenuation which corresponds approximately to that of an optical fiber with a single core. This requires that the fiber design does not cause additional attenuation or interfere with the independent information transmission of the signal cores as an interference signal. However, this can be caused by so-called “crosstalk” between the multiple cores, in particular if they are too close to one another. This effect thus requires a certain minimum distance to be maintained between the fiber cores. For these reasons, there is a need to use the cross-sectional area available in the radial cross-section of the multicore fiber as completely as possible for occupancy by the multiple cores.

The additional marker zones to be introduced into the fiber design should therefore take up a small proportion of the fiber cross-section. A small size of the marker zones is also advantageous in order to counteract other undesired effects, such as so-called fiber curl or stresses induced in the fiber. The diameter of the channel for receiving the marker element is therefore small and generally significantly smaller than the diameter of the bores for receiving the core rods. Typically, the channel diameter in the hollow glass cladding cylinder prior to the fiber drawing process is less than 15 mm, accompanied by an aspect ratio above 65 (for a hollow cylinder length of about 1 m).

The dimensionally accurate production and exact alignment of such thin channels in a hollow glass cladding cylinder are difficult even when using high-precision drilling machines. In addition, it has been shown that cracks are increasingly produced in the channel wall, especially during the drilling of thin channels. The cost of producing the hollow glass cladding cylinder from synthetic quartz glass is high and the loss is particularly painful, when, of all things, the small bore for receiving the marker element leads to the otherwise finished hollow glass cladding cylinder being rejected.

To make matters worse, the cutting and splicing of the multicore fiber can be carried out at any position according to the specific requirements when used as intended, so that a consistent geometry along the entire fiber length must be relied upon in order to not to have to rely on measurements.

It is therefore an object of the invention to provide a method for producing multicore fibers without a central signal core, which reduces the disadvantages of the known methods and in which, in particular, the risk of rejects during the completion of the hollow glass cladding cylinder is reduced.

In addition, the object of the invention is to provide a semi-finished product which is suitable for producing a multicore fiber without a central signal core, which is characterized in particular by a low “fiber curl.”

A property of glass fibers which is defined as a degree of curvature over a certain length of the fiber is referred to as “fiber curl.” The curvature results from thermal stresses which arise during the fiber production. A high “fiber curl” makes low-attenuation splicing of the multicore fiber more difficult.

### GENERAL DESCRIPTION OF THE INVENTION

With regard to the method, this object is achieved according to the invention, based on the method mentioned at the outset, in that a recess extending in the direction of the filling rod longitudinal axis is produced in or on the filling rod, into which recess a marker element made of marker glass is inserted or which forms the marker element.

A hollow glass cladding cylinder with a central bore is used. Such hollow cylinders are obtained, for example and preferably, using the OVD (Outside Vapor Deposition) method after the deposition mandrel has been removed. The production of hollow glass cladding cylinders using the OVD method is cost effective compared to other production methods, in particular compared to the VAD (Vapor Phase Axial Deposition) method. However, it has the disadvantage that the aforementioned central bore remains. Said central bore can be completely or partially closed by means of a glass filling material provided by a plurality of filling rods or by a single filling rod containing the glass filling material.

In embodiments in which the chemical composition of the glass filling rod corresponds to that of the cladding glass, the glass filling material of the filling rod in the multicore fiber forms a part of the optical cladding. In embodiments in which the chemical compositions of glass filling material and cladding glass differ, the glass filling material of the filling rod in the multicore fiber can have an additional function, for example it can act as a “stress zone” which generates and/or compensates for compressive or tensile stresses acting in the radial direction within the fiber.

The method according to the invention is used to produce a multicore fiber without a central signal core. The central bore is used to insert a marker element in addition to the glass filling material of the filling rod. The glass filling material does not contain any core region suitable for signal transmission.

At least one recess extending in the direction of the longitudinal axis of the filling rod is produced in or on the filling rod, into which the marker element is inserted or which forms the marker element.

The marker element is present in the component group as a component, as a coating of a component or as a cavity, and forms a continuous, line-like marker zone made of a marker material or air in the multicore fiber. The marker zone can be used, for example, during splicing for symmetry breaking and for unambiguous identification of the signal cores and their positions relative to each other and in relation to the fiber central axis.

The recess is, for example, a hollow channel which extends through the filling rod along the filling rod longitudinal axis. In this case, the filling rod forms the edge of a marker element in the form of an air-filled, elongated cavity. Or the marker element is arranged in a recess on the outer cladding surface of a cylindrical filling rod.

Since the marker element is located in or on the glass filling rod and thus within the central bore of the hollow glass cladding cylinder but not in the cladding glass of the hollow cylinder, the need for adapting the hollow glass cladding cylinder for the purpose of inserting the marker element is eliminated, for example by mechanical processing and in particular by producing a bore for receiving the marker element in the hollow glass cladding cylinder. The risk of damage associated with adapting the hollow glass cladding cylinder in this way is therefore eliminated.

The dimensional stability and the straightness of the central bore of the hollow glass cladding cylinder can be easily ensured by the OVD production method itself and, if necessary, by subsequent measures. Suitable subsequent measures include, for example, mechanical reworking of the central bore and/or an elongation process to which the initial hollow cylinder produced in the OVD deposition process is subjected in order to elongate a tube strand therefrom from which the hollow glass cladding cylinder is produced or from which a plurality of hollow glass cladding cylinders is cut to length. The elongation process is preferably carried out without the use of a shaping tool which engages the drawn off tube strand in order to avoid damaging the tube strand surface.

Similarly, the dimensional stability and straightness of a filling rod to be inserted precisely into the central bore can be ensured comparatively easily by mechanical machining and/or by means of such an elongation process. This mechanical machining can optionally be an external machining method, which is generally significantly less complex than an internal machining method.

Axially parallel alignment of the marker element is facilitated by it being formed by the recess of the filling rod, which extends in the direction of the filling rod longitudinal axis, or by it being inserted into the recess extending in the direction of the filling rod longitudinal axis.

The marker element is inserted into the recess, for example, by inserting a cylindrical component (rod or tube) made of a marker glass, which extends parallel to the outer cladding surface of the filling rod, or by introducing a bed of particles from the marker glass or by internal coating of the recess with the marker glass.

The recess is designed, for example, as a bore in the filling rod and preferably as a longitudinal slot (longitudinal groove) on the outer cladding surface of the filling rod. The groove-shaped recess is filled, for example, with a cylindrical component made of a marker material or with a particulate marker material. The particulate marker material can have a certain dimensional stability through thermal compression or by adding binder. The marker material fills the recess completely or partially. The recess thereby ensures a positive fit between the marker element and the filling rod. The marker element and filling rod can also be connected to one another in advance (i.e., before insertion into the central bore) by material bonding, for example by sintering or fusing.

A procedure in which a filling rod is provided with a longitudinal groove is particularly preferred. On the one hand, a longitudinal groove in the filling rod outer cladding surface is particularly easy and geometrically precise to produce compared to a bore in the filling rod, for example by milling by means of mechanical milling cutter or by laser ablation. On the other hand, the longitudinal groove produced in this way is just as precise and straight as the filling rod itself. Furthermore, the depth or the opening width of the longitudinal groove can virtually be as small as desired, for example both less than 15 mm, preferably less than 10 mm and particularly preferably less than 5 mm. The longitudinal groove can be reshaped as a wall of an air-filled hollow channel which can serve as a marker element, or the longitudinal groove can also be filled with a marker material. This means that geometrically precise marker elements with a small volume can be produced in a simple manner, which have a deviation in their axial alignment of less than 0.3 mm/m in the pre-form or in the component group and which accordingly form correspondingly small and highly precise marker zones in the multicore fiber.

The longitudinal groove is filled with the marker element, for example, by inserting a cylindrical component (rod or tube), made of a marker material or by introducing a bed of particles from the marker material or by internal coating of the longitudinal groove with the marker material. The cylindrical component made of the marker material or respectively the bed from the marker material can additionally be fixed in the longitudinal groove by fusing.

The straightness of the filling rod and central bore that is comparatively easy to achieve also facilitates the axially parallel alignment of the marker element. This applies in particular to a particularly preferred procedure in which the marker element extends along the filling rod longitudinal axis and is fused into the recess prior to reshaping to form the pre-form or the multicore fiber.

The marker element (component, bed, layer) is thereby fixed in the recess by fusing. For this purpose, it is melted into the recess over at least part of its length, preferably locally at several points distributed over its length and ideally over its entire length. The filling rod filled with the marker element material is also referred to below as a “modified filling rod.”

By melting the marker element into the recess prior to reshaping the component group to form a multicore fiber or a pre-form, it can be ensured that the side edges of the recess filled with the melted marker element form largely stepless, continuous transitions to the outer cladding surface of the modified filling rod, thus avoiding structural defects during the fiber drawing process. This has a positive effect on the dimensional stability of the multicore fiber. The marker element completely fills the recess, for example, and ideally has a curvature adapted to the outer contour of the filling rod outer cladding surface.

Thus, in a preferred procedure, it is provided that the marker element has a length and that melting takes place along at least 80% of this length, preferably along at least 90% of this length, completely, in sections or at certain points.

The melting of the marker element preferably comprises a method step in which the filling rod is mounted with a horizontally oriented filling rod longitudinal axis in such a way that the recess is located on an upper side of the filling rod outer cladding surface, wherein the material of the marker element inserted in the recess is heated and softened by means of a heat source.

By melting the marker element with the filling rod longitudinal axis oriented horizontally, gravity causes the material of the marker element to sink downwards as soon as it has been heated and softened locally by means of a burner or a laser, for example, and it thereby fills cavities remaining in the recess. The surface tension can lead to rounding of the free surface region adjacent to the atmosphere.

In this way, it is much better and easier to fill the recess evenly and preferably completely than would be the case, for example, if the marker element and the recess were oriented in a vertical direction during the melting process.

The marker element melted into the recess is fixed in relation to the filling rod, which simplifies the handling of the modified filling rod in the further fiber production process. During melting, a certain degree of rounding of the marker material and thus an adaptation to the contour of the outer cladding surface of the filling rod can be achieved due to the surface tension. After melting the marker element, the accuracy and quality of the melting of the modified filling rod can be checked and, if necessary, improved.

In this way, the component group is equipped with a marker element without having to produce a separate hole in the hollow glass cladding cylinder-associated with the risks and difficulties explained above. At the same time, despite the high aspect ratio, a high level of accuracy can be guaranteed, which is manifested, for example, in the pre-form or in the component group in that the axis parallelism of the marker element has a deviation of less than 0.3 mm/m.

In a preferred procedure, the marker element is present as a rod which extends parallel to a filling rod or to a plurality of filling rods within the central bore.

In a further preferred procedure, the marker element is present as a layer which is applied in the recess of the filling rod.

Two or more, for example four to seven additional longitudinal bores (core rod bores) are usually made in the hollow cylinder, the longitudinal axes of which run parallel to the longitudinal axis of the central bore. The core rod bores are through-bores or blind bores and serve to receive at least one core rod made from the core glass in each case. Viewed in the radial direction, the composition of the core glass is uniformly homogeneous or changes gradually or in stages. It differs from that of the cladding glass in such a way that light guidance in the core glass region is ensured.

The desired number of core rod bores is either produced in one operation and occupied in each case by at least one core rod, or only one core rod bore or only a first share of the desired number of core rod bores is produced in advance, this in each case being occupied by at least one core rod, and the core rod bores occupied by the core rods are collapsed (this reshaping process is also referred to here as “consolidation”), before the remaining share or a further share of the core rod bores is produced in a second or further operation, and this share is also occupied in each case by at least one core rod and is optionally collapsed. In the simplest case, all core rods have the same dimensions and consist of the same core glass. However, the core rods can also differ in terms of their dimensions and/or in the composition of the corresponding core glass.

The filling of the central bore with the filling rod including the marker element can take place before or after all the core rod bores have been produced and/or filled, or it can take place before or after some of the core rod bores have been produced and/or filled. In a preferred method, the central bore is filled with the filling rod and the marker element, then the filled central bore is collapsed by heating, and only then are the desired core rod bores produced. In another preferred method, a first share of the desired number of core rod bores is produced and fitted with at least one core rod, the central bore is filled with the filling rod and the marker element, then the filled core rod bores and the filled central bore are consolidated by heating, and only then is a second portion of the core rod bores produced.

The component group produced in this way is reshaped and either drawn directly to form the multicore fiber or is consolidated to form a pre-form for the multicore fiber, wherein the consolidation process can be associated with a simultaneous elongation process. The “consolidated pre-form” produced in this way is optionally drawn to form the multicore fiber or is further processed to form a “secondary pre-form.” Further processing to form the “secondary pre-form” comprises, for example, producing further bores in the glass cladding region and their occupation with core glass or other glasses or carrying out one or more of the following hot forming processes once or repeatedly: collapsing on additional cladding material, collapsing, elongating, collapsing and simultaneous elongating. The multicore fiber is drawn from the secondary pre-form produced by further processing.

In a preferred procedure, the production of the component group comprises the following method steps:
(a) providing the hollow cylinder containing the cladding glass,
(b) providing multiple core rods containing the core glass,
(c) providing a filling rod comprising a filling rod longitudinal axis and containing the glass filling material,
(d) generating the at least one recess on the outer cladding surface of the filling rod,
(e) providing the marker element,
(f) arranging and melting the marker element into the groove,
(g) producing core rod bores extending along the hollow cylinder longitudinal axis,
(h) introducing the filling rod and the marker element into the central bore, and
(i) introducing the core rods into the core rod bores, forming the component group.

The component group produced in this way comprises the hollow cylinder, at least one modified filling rod, which is fused to at least one marker element, and core rods. The list characters (a) to (g) only specify a preferred but not mandatory order of the method steps. Core rods of the component group are also referred to here as core rods if they have already been melted in their respective core rod bore.

The marker element extends along the filling rod longitudinal axis, preferably over its entire length, i.e., from the first filling rod end to the second filling rod end.

By fusing with the filling rod, the marker element benefits in particular from its straightness and alignment; these properties are virtually transferred to the marker element.

The marker element is, for example, a tube and preferably a rod. In the case of a marker element in the form of a tube, the tube wall can contain a material which has a higher viscosity than the cladding glass, so that during the fiber drawing process the bore does not collapse completely and is maintained in the finished multicore fiber as a cavity (“airline”).

The cross-sectional geometry, optionally the outer diameter and the length of the filling rod are adapted to the geometry and length of the hollow cylinder central bore. The central bore is preferably filled leaving a circumferential gap with a gap width of less than 2 mm, particularly preferably a maximum of 1 mm. For example, in the case of a central bore in the range of 38 mm to 78 mm, the filling rod diameter is in the range of 36 mm to 76 mm.

The marker element forms an air-filled, elongated cavity (channel) or it contains a marker material which preferably differs in at least one physical and/or chemical property from the cladding glass and from the glass filling material of the filling rod, wherein the property is preferably selected from: refractive index, color, fluorescence, and/or specific glass density.

The property (or the properties) which distinguish(es) the marker element from the glasses of the component group have an impact in particular on the visual appearance of the marker element and is/are preferably detectable by means of an optical sensor. The glass composition of a marker glass can—like for example also the glass filling material of the filling rod—be based on quartz glass. The refractive index of quartz glass can be changed by doping. For example, doping a marker quartz glass with fluorine causes a reduction in the refractive index with respect to undoped quartz glass. Incorporating carbon into the marker quartz glass can lead to a black coloration. Depending on the oxidation state, doping the marker quartz glass with titanium causes a gray or blue coloration. Doping the marker quartz glass with rare earth metals or germanium oxide manifests itself in fluorescence at dopant-specific wavelengths. The specific glass density of the marker element can be changed by pores and manifests itself in a reduction of the optical transparency with respect to bubble-free glass.

With regard to the semi-finished product for producing a multicore fiber, the above-mentioned technical object, starting from the semi-finished product mentioned at the outset, is achieved according to the invention in that the filling rod comprises a recess extending in the direction of the filling rod longitudinal axis, into which recess a marker element made of marker glass is inserted or which forms the marker element extending along the central bore longitudinal axis and the filling rod longitudinal axis.

The semi-finished product according to the invention is used to produce a multicore fiber without central signal core. It comprises a hollow cylinder comprising a cladding glass region made of cladding glass and a plurality of core glass regions occupied with a core glass. The hollow cylinder central bore is completely or at least partially occupied by a filling rod made of glass filling material. At least one recess is located in or on the filling rod extending in the direction of the filling rod longitudinal axis, into which recess the marker element is inserted or which forms the marker element.

The central bore longitudinal axis and the filling rod longitudinal axis run coaxially with respect to one another in the semi-finished product.

The number of core glass regions is at least two, preferably four to seven. For example, they are each designed as core rod bores running parallel to the hollow cylinder longitudinal axis in the cladding glass region of the hollow cylinder, and are each occupied by a core rod. The filling rod is inserted into the hollow cylinder central bore and fills it at least partially. At least one marker element is also located in the hollow cylinder central bore. Said marker element is connected to the filling rod either by being formed as a recess in the filling rod or by at least partially filling a recess in or on the filling rod. The filling rod filled in this way is also referred to here as a “modified filling rod.” The filling rod does not contain any core region suitable for signal transmission.

The semi-finished product forms a component group when all or some core rods, filling rods and marker elements are merely inserted in their respective bores or recesses, but are not yet fused therein. The semi-finished product forms a pre-form (also referred to as a “consolidated pre-form”) when all bores or recesses have collapsed and the core rods, filling rods and marker elements have fused to one another or to the hollow cylinder.

The hollow glass cladding cylinder has a central bore. Such hollow cylinders are, for example, obtained cost-effectively using the OVD method after the deposition mandrel has been removed. The central bore is completely or partially closed by means of a glass filling material provided by a plurality of filling rods or preferably by a single filling rod.

In embodiments in which the chemical composition of the glass filler rod corresponds to that of the cladding glass, the glass filling material of the filling rod in the multicore fiber forms a part of the optical cladding. In embodiments in which the chemical compositions of glass filling rod and cladding glass differ, the glass filling material of the filling rod in the multicore fiber can have an additional function, for example it can act as a “stress zone” which generates and/or compensates for compressive or tensile stresses acting in the radial direction within the fiber.

The central bore is used to receive a marker element made of marker glass in addition to the filling rod. The marker element is present in the semi-finished product, for example as an elongated cavity or as a consolidated or non-consolidated component made of a marker material or as a coating of such a component with the marker material, and in the multicore fiber forms a continuous, line-like marker zone made of the marker material or an air-filled hollow channel.

The marker element is located in or on the filling rod. For example, it is located in the form of air or another gas in a recess which is designed as a hollow channel which extends through the filling rod along the filling rod longitudinal axis, or it is attached in a recess on the outer cladding of the filler rod.

Since the marker element is located in or on the filling rod and thus within the central bore of the hollow glass cladding cylinder but not in the cladding glass of the hollow cylinder, the need for adapting the hollow glass cladding cylinder for the purpose of inserting the marker element is eliminated, for example by mechanical processing and in particular by producing a separate bore for receiving the marker element in the hollow glass cladding cylinder. The risk of damage associated with adapting the hollow glass cladding cylinder in this way is therefore eliminated.

The dimensional stability and the straightness of the central bore can be easily ensured by the OVD production method itself and, if necessary, by subsequent measures. Subsequent measures suitable for adjusting dimensional stability and straightness include, for example, mechanical reworking of the central bore and/or an elongation process to which the initial hollow cylinder produced in the OVD deposition process is subjected in order to elongate a tube strand therefrom from which the hollow glass cladding cylinder is produced or from which a plurality of hollow glass cladding cylinders is cut to length. The elongation process is preferably carried out without the use of a shaping tool which engages the drawn off tube strand in order to avoid damaging the tube strand surface. Similarly, the dimensional stability and the straightness of the filling rod to be inserted precisely into the central bore can be ensured comparatively easily by mechanical machining and/or by means of such an elongation process. This mechanical machining can optionally be an external machining method, which is generally significantly less complex than an internal machining method.

Axially parallel alignment of the marker element is facilitated by it being formed by the recess of the filling rod, which extends in the direction of the filling rod longitudinal axis, or by it being inserted into the recess extending in the direction of the filling rod longitudinal axis.

The recess is designed, for example, as a bore in the filling rod and preferably as a longitudinal slot (longitudinal groove) on the outer cladding surface of the filling rod. The groove-shaped recess is filled—forming a “modified filling rod”—for example with a cylindrical component made of a marker material or with a particulate marker material. The particulate marker material can have a certain dimensional stability through thermal compression or by adding binder. The marker material fills the recess completely or partially. The recess thereby ensures a positive fit between the marker element and the filling rod. The marker element and filling rod can also be connected to one another in advance (i.e., before insertion into the central bore) by material bonding, for example by sintering or fusing.

In this context, an embodiment in which the recess of the filling rod is designed as a longitudinal groove is particularly preferred. On the one hand, a longitudinal groove in the filling rod outer cladding surface is particularly easy and geometrically precise to produce compared to a bore in the filling rod. On the other hand, the longitudinal groove produced in this way is just as precise and straight as the filling rod itself. Furthermore, the depth or the opening width of the longitudinal groove can virtually be as small as desired, for example both less than 15 mm, preferably less than 10 mm and particularly preferably less than 5 mm. This means that geometrically precise marker elements with a small volume are available, which marker elements have a deviation in their axial alignment of less than 0.3 mm/m in the pre-form or in the component group and accordingly form correspondingly small and highly precise marker zones in the multicore fiber.

The marker material is present, for example, in the form of a cylindrical component (rod or tube) made of the marker material, or is formed by a bed of particles from the marker material or by internal coating of the longitudinal groove with the marker material. The cylindrical component made of the marker material or respectively the bed from the marker material can also be fixed in the longitudinal groove by fusing.

The straightness of the filling rod and central bore that is comparatively easy to achieve also facilitates the axially parallel alignment of the marker element. This applies in particular to a particularly preferred embodiment of the semi-finished product in which the marker element extends along the filling rod longitudinal axis and is melted into the recess.

The marker element (component, bed, layer) is fixed in the recess by fusing. For this purpose, it is melted into the recess over at least part of its length, preferably locally at several points distributed over its length and ideally over its entire length. The result is a modified filling rod filled with the marker element material.

By melting the marker element into the recess, it can be ensured that the side edges of the recess filled with the melted marker element form largely stepless, continuous transitions to the outer cladding surface of the filling rod, thus avoiding structural defects during the fiber drawing process. This has a positive effect on the dimensional stability of the multicore fiber. The marker element completely fills the recess, for example, and ideally has a curvature adapted to the outer contour of the filling rod outer cladding surface.

Thus, in a preferred embodiment, it is provided that the marker element has a length and that it is melted into this recess along at least 80% of this length, preferably along at least 90% of this length, completely, in sections or at certain points.

The marker element melted into the recess is fixed in relation to the filling rod, which simplifies its handling in the further fiber production process. During melting, a certain degree of rounding of the marker material and thus an adaptation to the contour of the outer cladding surface of the filling rod can be achieved due to the surface tension. After melting the marker element, freedom from defects and the quality of the melting process can be monitored and, if necessary, improved.

As a result, the semi-finished product is equipped with a marker element for which no separate bore had to be produced in the hollow glass cladding cylinder-associated with the risks and difficulties explained above. At the same time, despite the high aspect ratio, a high level of accuracy can be guaranteed, which is manifested, for example, in the semi-finished product in that the axis parallelism of the marker element has a deviation of less than 0.3 mm/m.

In a preferred embodiment, the recess comprises a bore and/or a longitudinal groove in the outer cladding surface of the filling rod, wherein the semi-finished product according to the invention furthermore comprises: the hollow cylinder comprising the central bore, at least two core rods containing the core glass and forming the core glass regions, the filling rod arranged in the central bore and at least one marker element attached in the recess of the filling rod.

The marker element is present, for example, as a rod which extends parallel to a filling rod or to a plurality of filling rods within the central bore. The marker element rods and filling rods can also be in consolidated form, i.e., in a form fused with their surroundings.

Two or more, for example four to seven, additional longitudinal bores (core rod bores) are made in the hollow cylinder, the longitudinal axes of which run parallel to the longitudinal axis of the central bore. The core rod bores are through-bores or blind bores and serve to receive at least one core rod made from the core glass in each case. Viewed in the radial direction, the composition of the core glass is uniformly homogeneous or changes gradually or in stages. It differs from that of the cladding glass in such a way that light guidance in the core glass region is ensured. In the simplest case, all core rods have the same dimensions and consist of the same core glass. However, the core rods can also differ in terms of their dimensions and/or in the composition of the corresponding core glass.

The semi-finished product is either drawn directly to form the multicore fiber or it is consolidated to form a pre-form for the multi-core fiber, wherein consolidating can be accompanied by simultaneous elongating. The “consolidated pre-form” produced in this way is optionally drawn to form the multicore fiber or is further processed to form a “secondary pre-form,” from which the MFK is then finally drawn.

The marker element extends along the filling rod longitudinal axis, preferably over its entire length, i.e., from the first filling rod end to the second filling rod end, and it is preferably attached to the filling rod.

By attaching it to the filler rod, the marker element benefits from the straightness and alignment thereof; these properties are quasi transferred to the marker element. The attachment is based, for example, on frictional connection, material connection, and/or positive connection between the filling rod and the marker element.

The marker element is preferably designed in the form of a cylindrical component made of a marker material or in the form of a layer or mass of the marker material connected to the filling rod. The at least one cylindrical component is, for example, a tube and preferably a rod. In the case of a marker element in the form of a tube, the tube wall can contain a material which has a higher viscosity than the cladding glass, so that during the fiber drawing process the bore does not collapse completely and is maintained in the finished multicore fiber as a cavity (“airline”).

The cross-sectional geometry, optionally the outer diameter and the length of the filling rod are adapted to the geometry and length of the hollow cylinder central bore. The central bore is preferably filled leaving a circumferential gap with a gap width of less than 2 mm, particularly preferably a maximum of 1 mm. For example, in the case of a central bore in the range of 38 mm to 78 mm, the filling rod diameter is in the range of 36 mm to 76 mm.

The marker element forms an air-filled, elongated cavity or channel or it contains a marker material which preferably differs in at least one physical and/or chemical property from the cladding glass and from the glass filling material of the filling rod, wherein the property is selected from: refractive index, color, fluorescence, and/or specific glass density.

The property (or the properties) which distinguish(es) the marker element from the glasses of the component group have an impact in particular on the visual appearance of the marker element and is/are preferably detectable by means of an optical sensor. The glass composition of a marker glass can-like for example also the glass filling material—be based on quartz glass. The refractive index of quartz glass can be changed by doping. For example, doping the marker quartz glass with fluorine causes a reduction in the refractive index with respect to undoped quartz glass. Incorporating carbon into the marker quartz glass can lead to a black coloration. Depending on the oxidation state, doping the marker quartz glass with titanium causes a gray or blue coloration. Doping the marker quartz glass with rare earth metals or germanium oxide manifests itself in fluorescence at dopant-specific wavelengths. The specific glass density of the marker element can be changed by pores and manifests itself in a reduction of the optical transparency with respect to bubble-free glass.

Based on the method according to the invention or using the semi-finished product according to the invention, a multicore fiber is obtained in which the signal cores are arranged outside a cladding circle around the fiber central axis and the marker zone is arranged within the cladding circle about the fiber central axis.

The type of the multicore fiber corresponds to that of the “multicore fiber without central signal core.” All signal cores are arranged outside the fiber central axis and completely outside of a cladding circle about the fiber central axis.

The multicore fiber is traversed by at least one continuous, line-like marker zone. The marker zone is used for symmetry breaking and to clearly identify the signal cores and their positions relative to one another and in relation to the fiber central axis.

Seen in the fiber cross-section, the—preferably only—marker zone lies within the aforementioned cladding circle defined by the signal cores, and thus in a region between the signal cores (and not: outside the signal cores), which also includes the fiber central axis. Surprisingly, it has been shown that a comparatively low fiber curl is imprinted on the multicore fiber with this positioning of the marker zone during the fiber drawing process. Without wishing to be bound by this theory, it can be assumed that positioning the marker zone in the inner region of the fiber cross-section exerts less influence on the symmetry of the fiber design than positioning it in the outer region. Apparently, this generates lower radial forces in the multicore fiber during the fiber drawing process.

### DEFINITIONS AND MEASUREMENT METHODS

Individual terms in the above description are further defined below. The definitions are part of the description of the invention. For terms and measurement methods that are not specifically defined in the description, the interpretation according to the International Telecommunication Union (ITU) is shall apply. In the event of an inconsistency between one of the following definitions and the rest of the description, the statements made elsewhere in the description take precedence.

### Hollow Glass Cladding Cylinder/Cladding Glass Region

The hollow cylinder contains a cladding glass. The cladding glass forms a cladding glass region with a central bore, outside of which the core glass regions designed for signal transmission are created. The cladding glass consists, for example, of undoped quartz glass, or it contains at least one dopant that decreases the refractive index of quartz glass. Fluorine and boron are dopants which can lower the refractive index of quartz glass. The hollow glass cladding cylinder is elongated and essentially cylindrical in shape. Deviations from the cylindrical shape can be present in the region of the end-face ends. The glass cladding cylinder is preferably produced using the OVD method.

### Core Rods/Core Glass Region

The core rods contain a core glass having a homogeneous or non-homogeneous refractive index profile in the radial direction. The core glass of each of the core rods forms a core glass region. The core rods can contain a region made of a core glass having a comparatively high refractive index and at least one further region made of another glass having a comparatively low refractive index; for example, a quartz glass doped with fluorine and/or chlorine. The glass having the highest refractive index is generally located in the central axis of the core rod. It consists, for example, of quartz glass, to which at least one dopant is added to increase the refractive index. In the multicore fiber, the core rod forms at least one signal core in which the signal to be transmitted is mainly transported. The signal core can adjoin other glass regions with a smaller refractive index which have also been provided by the core rod.

### Filling Rod/Modified Filling Rod

The filling rod contains a glass filling material. The filling rod does not form a signal core in the multicore fiber that can be used for signal transmission. In the simplest case, the composition of the glass filling material corresponds to that of the cladding glass. However, the composition can also differ from that of the cladding glass in order to impart an additional property to the multicore fiber. For example, it can have a lower coefficient of thermal expansion than the cladding glass.

The modified filling rod is connected to a marker element and forms a manageable unit with it. It contains glass filling material and marker material.

### Marker Element/Marker Material/Marker Glass

The marker element contains a marker material or consists partly of air or another gas. In particular, the marker element contains at least one marker glass. The chemical composition of the marker material differs from that of the cladding glass and the glass filling material of the filling rod, and/or the density of the marker material differs from that of the cladding glass and the glass filling material. The marker element is present in the pre-form and in the component group as a component or as a layer or mass on a component and forms an optically detectable marker zone in the multicore fiber.

### Component Group/Consolidated Pre-Form/Secondary Pre-Form/Semi-Finished Product

The “component group” comprises the hollow glass cladding cylinder with core rods inserted therein, the at least one filling rod and the at least one marker element. By fixing the core rods in the core rod bores, for example by narrowing a hollow glass cladding cylinder end or by collapsing and fusing, a “pre-form” is obtained, which is also referred to here as a “consolidated pre-form.” The component group or the (consolidated) pre-form is elongated to form a “secondary pre-form,” or to directly form the multicore fiber. The term “semi-finished product” here subsumes the component group, the consolidated pre-form and the secondary pre-form. Reshaping the component group comprises the elongation to form the multicore fiber or the formation of the consolidated pre-form.

### Quartz Glass

Quartz glass is, for example, a melted product from naturally occurring SiO₂ raw material (natural quartz glass), or it is synthetically produced (synthetic quartz glass), or consists of mixtures of these quartz glass types. Synthetic, transparent quartz glass is obtained for example by flame hydrolysis or oxidation of synthetically produced silicon compounds, by polycondensation of organic silicon compounds according to what is referred to as the sol-gel method, or by hydrolysis and precipitation of inorganic silicon compounds in a liquid.

### Fusing

When components made of glass are referred to, fusing is understood to mean that the components are fused to one another on a contact surface. Fusing takes place by heating the components at least in the region of the contact surface by means of a heat source, such as a furnace, a burner, or a laser.

### Position Indications: Top/Bottom

These indications relate to positions during the elongation process and/or during the fiber drawing process. “Bottom” denotes the position in the direction of the drawing process; “top” denotes the position counter to the direction of the drawing process.

### Cross-Section

The section taken perpendicular to the longitudinal direction/longitudinal axis.

### Longitudinal Section

A section taken parallel to the longitudinal direction/longitudinal axis.

### Bore

The terms “bore,” “central bore,” “inner bore” or “longitudinal bore” refer to holes with a cylindrical but otherwise arbitrary internal geometry. They are produced, for example, by a drilling process or they are produced by depositing a material layer on the outer cladding surface of a mandrel by means of a deposition process or a pressing process and then removing the mandrel.

### Axially Parallel Alignment/Axis Parallelism

The reference axis in each case is the longitudinal axis of the hollow glass cladding cylinder or the central axis of the multicore fiber.

### EXEMPLARY EMBODIMENT

The invention is explained in more detail below with reference to an exemplary embodiment and a drawing. In detail, in a schematic representation,

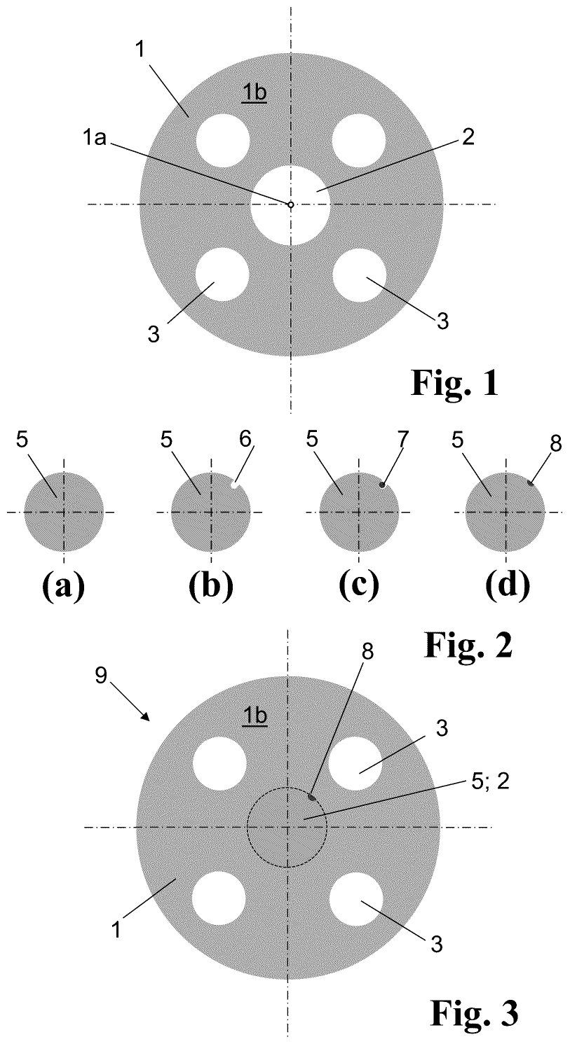

FIG. 1 shows a cross-section of a hollow glass cladding cylinder with a central bore and through-bores for receiving core rods,

FIG. 2 shows processing steps (a) to (d) for the production of a filling rod with a marker element for insertion into the central bore of the hollow glass cladding cylinder of FIG. 1,

FIG. 3 shows the component group of hollow glass cladding cylinder and inserted filling rod including marker element,

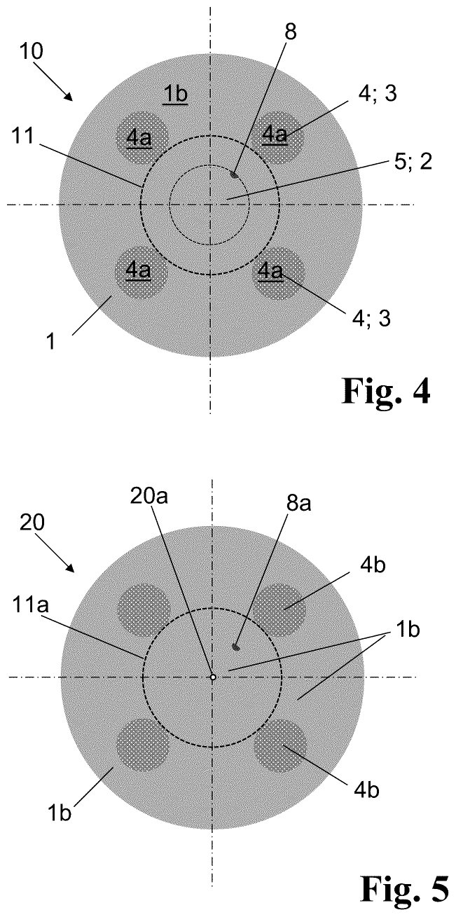

FIG. 4 shows a cross-section of a consolidated pre-form of hollow glass cladding cylinder, inserted filling rod including marker element and core rods inserted into the through-bores, and

FIG. 5 shows a cross-section of a multicore fiber drawn from the pre-form of FIG. 4.

FIG. 1 schematically shows a cross-section of a hollow cylinder 1 made of a cladding glass, which serves as a base body for the production of a multicore fiber.

The hollow cylinder 1 is produced in a known manner using the OVD method. In this method, SiO₂ soot particles are formed by a high-purity SiO₂ starting material, for example silicon tetrachloride, being passed through a deposition burner and supplied to a burner flame in which it is oxidized to solid SiO₂. This is deposited in the form of fine SiO₂ soot particles from the gas phase on the outer cladding surface of a cylindrical deposition mandrel rotating about its longitudinal axis, wherein the deposition burner executes a reversing back and forth movement along the deposition mandrel longitudinal axis. An SiO₂ soot body forms on the outer cladding surface of the deposition mandrel. After completion of the deposition process, the deposition mandrel is removed so that an inner bore 2 remains. The SiO₂ soot body is then vitrified in a furnace under vacuum.

The resulting hollow cylinder 1 consists of undoped, synthetically produced quartz glass, which forms the cladding glass region 1b. The hollow cylinder has a length of 1500 mm and is adjusted to a nominal outer diameter of 200 mm by cylindrical grinding and to an inner diameter of 42 mm by drilling and honing. Four bores 3 are produced in a predetermined (here quadratic) configuration by mechanical drilling in the direction of the hollow cylinder longitudinal axis 1b, which runs perpendicular to the sheet plane in the illustration of FIG. 1. The bores 3 are used to receive core rods (FIG. 4) and have a diameter of 30 mm. The bores extend through the entire hollow cylinder 1 (through-bores). In an alternative embodiment, the bores are designed as blind bores.

FIG. 2 schematically shows method steps for producing a filling rod 5. The filling rod 5 shown in FIG. 2(a) preferably consists of the same glass as the hollow cylinder 1, i.e., of undoped quartz glass. The known methods, such as VAD (Vapor Phase Axial Deposition) methods, OVD (Outside Vapor Deposition) methods or MCVD (Modified Chemical Vapor Deposition) methods are suitable for its production. It is used to fill the hollow cylinder inner bore 2 and has a length of about 1500 mm and an initial outer diameter of about 45 mm, which is reduced to about 40 mm by cylindrical grinding. Possible disturbances of the outer cladding surface 5b and bends are eliminated by the cylindrical grinding. Alternatively or additionally, the diameter adaptation and surface improvement is achieved by elongation in a tool-free elongation process. In this illustration, the filling rod longitudinal axis 5a also runs perpendicular to the sheet plane.

FIG. 2(b) shows that a longitudinal groove 6 has been milled into the outer cladding surface of the filling rod 5. The longitudinal groove 6 extends over the entire length of the filling rod 5. It has a U-shape with a rounded base and straight side walls. Its opening width and depth are each 6 mm. In a subsequent method step, a hollow channel can be produced from the longitudinal groove (6), which forms a marker element within the meaning of the invention. This is explained in more detail below with reference to FIG. 4.

FIG. 2(c) shows the longitudinal groove 6 with a marker rod 7 inserted therein. The marker rod 7 has a diameter of 5 mm. It consists of synthetically produced quartz glass doped with fluorine and can be obtained commercially under the name F320. Both the viscosity and the refractive index of the fluorine-doped quartz glass of the marker rod 7 are smaller than in the undoped quartz glass from which the hollow cylinder 1 and the filling rod 5 are made. The marker rod 7 is obtained by elongating a starting cylinder made of the F320 quartz glass using a tool-free method. It has a smooth surface produced in the melt flow and is characterized by high dimensional stability, so that it can be inserted into the narrow longitudinal groove 6 without any difficulty and with a precise fit.

The filling rod 5 and the marker rod 7 are then fused together. The filling rod 5 is mounted with its longitudinal axis 5a oriented horizontally in such a way that the longitudinal groove 6 is located on its upper side. The marker rod 7 inserted into the longitudinal groove 6 is first heated at certain points by means of a burner so that it is fixed in the longitudinal groove at three approximately evenly distributed fixing points, which are located at the ends and in the middle of the marker rod 7 and which are distributed over 95% of its length. It is then heated evenly by means of the burner until the fluorine-doped quartz glass softens and deforms due to its comparatively low viscosity, so that it sinks into the longitudinal groove 6 and fills it up. Due to the surface tension, the surface of the softened glass mass adjacent to the free atmosphere shows a certain bulge, so that a pronounced step between the lateral edges of the longitudinal groove 6 and the outer cladding surface 5b of the filling rod 5 is avoided.

FIG. 2(d) shows the marker glass mass 8 after softening, deforming, and fusing with the former filling rod 5 and the resulting modified filling rod 5c filled with marker glass mass 8. The glass volume of the former marker rod 7 is matched to the inner volume of the longitudinal groove 6 such that the marker glass mass 8 just completely fills the longitudinal groove 6.

The modified filling rod 5c filled in this way with the marker glass mass 8 is inserted into the inner bore 2 of the hollow cylinder 1. FIG. 3 schematically shows the component group 9 of hollow cylinder 1, and modified filling rod 5c with the marker glass mass 8.

Moreover, four core rods 4 made of germanium-doped quartz glass with a length of about 1500 mm and an outer diameter of about 28 mm are produced. Known techniques are also suitable for this purpose, for example the MCVD (Modified Chemical Vapor Deposition) method.

The core rods 4 are inserted into the bores 3. Subsequently, the component group 9 of hollow glass cladding cylinder 1, modified filling rod 5c, and the core rods 4 is heated, so that the inner bore 2 and the annular gaps around the core rods 4 close and all components of group 9 are fused together.

FIG. 4 schematically shows the component group fixed in this way of hollow glass cladding cylinder 1, modified filling rod 5c, and the core rods 4, which forms the consolidated pre-form 10. All core rods 4 form separate, circular core glass regions 4a, which are located completely outside of a cladding circle 11, whereas the marker element 8 is located completely within this cladding circle 11.

The consolidated pre-form 10 is then elongated to form a secondary pre-form. Thereby, the pre-form 10 is held in an elongating device by means of a holder in a vertical alignment of the hollow cylinder longitudinal axis 1a. The secondary pre-form produced in this way is finally drawn in the usual manner in a drawing device to form a multicore fiber 20.

In this embodiment, the marker element 8 is present as a marker glass mass 8, which has been produced by reshaping the original marker rod 7. In an alternative procedure, the longitudinal groove 6 is unfilled (no rod or tube is inserted) when the component group 9 is consolidated into the pre-form 10, and the longitudinal groove 6 is prevented from collapsing completely by generating and maintaining an overpressure in it. In this way, a cavity is produced which extends along the longitudinal axis 1a and which is present in the multicore fiber as an air-filled hollow channel. The hollow channel can serve as a marker zone, since the refractive index of air differs significantly from that of the cladding glass 1b.

FIG. 5 schematically shows the cross-section of the multicore fiber 20. Apart from the smaller radial dimensions, this substantially corresponds to the cross-section of the consolidated pre-form 10. The core glass regions (4a) of the former core rods (4) form signal cores 4b, which extend along the fiber longitudinal axis 20a; the former filling rod (5) has become part of the cladding glass region 1b and no longer can be distinguished visually therefrom, and the former marker element (8) forms a marker zone 8a. All signal cores 4b are located completely outside of the cladding circle 11a, whereas the marker zone 8a is located completely within this cladding circle 11a. The marker zone 8a is characterized by a small size, so that it imposes a low tension on the multicore fiber 20 during the fiber drawing process, and, as a result, a low fiber curl occurs.

1. A method for producing a multicore fiber, comprising a method step in which a component group is reshaped to form the multicore fiber or a pre-form for the multicore fiber, which comprises a hollow cylinder comprising a central bore and a hollow cylinder longitudinal axis, which hollow cylinder comprises a cladding glass region made of cladding glass and a plurality of core glass regions provided with a core glass, wherein at least a part of the central bore is occupied by a glass filling rod comprising a filling rod longitudinal axis and a filling rod outer cladding surface, wherein a recess extending in the direction of the filling rod longitudinal axis is produced in or on the filling rod, into which recess a marker element made of marker glass is inserted or which forms the marker element.

2. The method according to claim 1, wherein the marker element extends along the filling rod longitudinal axis and is melted into the recess prior to reshaping to form the pre-form or the multicore fiber.

3. The method according to claim 1, wherein the marker element has a length and in that melting takes place along at least 80% of this length, preferably along at least 90% of this length, completely, in sections or at certain points.

4. The method according to claim 1, wherein melting of the marker element comprises a method step in which the filling rod with the horizontally oriented filling rod longitudinal axis is mounted in such a way that the recess is located on an upper side of the filling rod outer cladding surface, wherein the material of the marker element is heated and softened by means of a heat source.

5. The method according to claim 1, wherein the production of the component group comprises the following method steps:
(a) providing the hollow cylinder containing the cladding glass,
(b) providing multiple core rods containing the core glass,
(c) providing a filling rod comprising a filling rod longitudinal axis and containing the glass filling material,
(d) producing the at least one recess on the outer cladding surface of the filling rod,
(e) providing the marker element,
(f) arranging and melting the marker element into the recess,
(g) producing core rod bores extending along the hollow cylinder longitudinal axis,
(h) introducing the filling rod and the marker element into the central bore, and
(i) introducing the core rods into the core rod bores, forming the component group.

6. The method according to claim 1, wherein the marker element is provided in the form of a cylindrical component or in the form of a layer or mass connected to the filling rod.

7. The method according to claim 1, wherein the recess comprises a bore and/or a longitudinal groove in the outer cladding surface of the filling rod.

8. The method according to claim 1, wherein the marker element forms an air-filled, elongate cavity or in that it contains a marker material which differs in at least one physical and/or chemical property from the cladding glass and from the glass filling material, wherein the property is selected from: refractive index, color, fluorescence, and/or specific glass density.

9. A semi-finished product for producing a multicore fiber, comprising a hollow cylinder comprising a central bore, which hollow cylinder comprises a cladding glass region made of cladding glass and a hollow cylinder longitudinal axis, and a plurality of core glass regions provided with a core glass within the cladding glass region, wherein at least a part of the central bore is occupied by a glass filling rod, which comprises a filling rod longitudinal axis and a filling rod outer cladding surface, wherein the filling rod comprises a recess which extends in the direction of the filling rod longitudinal axis and into which a marker element made of marker glass is inserted, or which forms the marker element, which extends along the central bore longitudinal axis and the filling rod longitudinal axis.

10. The semi-finished product according to claim 9, wherein the marker element has a length and in that it is melted into the recess, completely, in sections or at points, along at least 80% of this length, preferably along at least 90%.

11. The semi-finished product according to claim 9, wherein the marker element comprises a channel filled with a gas.

12. The semi-finished product according to claim 9, wherein the recess comprises a bore and/or a longitudinal groove in the outer cladding surface of the filling rod, and in that the semi-finished product further comprises: the hollow cylinder comprising the central bore, at least two core rods containing the core glass and forming the core glass regions, the filling rod arranged in the central bore, and at least one marker element attached in the recess of the filling rod.

13. The semi-finished product according to claim 9, wherein the marker element is present in the form of a cylindrical component or in the form of a layer or mass connected to the filling rod.

14. The semi-finished product according to claim 9, wherein the marker element forms an air-filled, elongate cavity, or in that it contains a marker material which differs in at least one physical and/or chemical property from the cladding glass, the core glass and the glass filling material, wherein the property is selected from: refractive index, color, fluorescence, and/or specific glass density.
